(19) United States
(12) Patent Application Publication
(10) Pub. No.: US 2002/0105700 A1
(43) Pub. Date: Aug. 8, 2002

(54) Method for transmitting an optical signal through free space

(75) Inventor: Bernd X. Weis, Korntal (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/053,691

(22) Filed: Jan. 24, 2002

(30) Foreign Application Priority Data
Feb. 3, 2001 (DE) 101 04 912.9

(51) Int. Cl. H04B 10/00; H04B 10/04

(52) U.S. Cl. 359/172; 359/180

(57) ABSTRACT

A method for transmitting a signal for the transfer of information from a signal source (1) to a signal sink (7) spatially remote therefrom wherein, at least over a part of the path between the signal source and the signal sink, the signal is transmitted as an optical signal over at least one free optical link between an optical transmitter (3) and an optical receiver (5), is characterised in that prior to its transmission the signal to be transmitted is split into signal packets (SP), that each signal packet is assigned a signal sequence (OH) characteristic of the signal packet and is transmitted together with the relevant signal packet at a higher bit rate than the original signal, and that the characteristic signal sequences are used to detect, and optionally correct, errors in the transmitted signal and/or to synchronise the transmission path. In this way a reliable transmission of optical signals through free space can be ensured using very simple means.

The present invention is based on a priority application DE 101 04 912.9, which is incorporated by reference herein.

### FIELD OF THE INVENTION

The invention relates to the field of telecommunications and more particularly to a method for transmitting a signal for the transfer of information from a signal source to a signal sink spatially remote therefrom wherein, at least over a part of the path between the signal source and the signal sink, the signal is transmitted as an optical signal via at least one free optical link between an optical transmitter and an optical receiver. The invention further relates to computer programs and devices for supporting and executing such a method, in particular suitable signal transmission devices, server units, processor modules and programmable gate array modules.

### BACKGROUND OF THE INVENTION

Such a method is known from EP 0 962 795 A2.

In some cases of signal transmission it can be advantageous to transmit optical signals through free space instead of using optical carrier media, such as for example optical fibres. Optical signal transmission through free space has cost advantages especially when the distances to be covered are short and the line of sight is essentially undisturbed.

In the above mentioned EP 0 962 795 A1, for example, the transmission of optical signals was used for a communication for exchanging data between two devices spatially remote from one another.

However, an optical communication link through free space requires a clear line of sight with no obstructions, so that nothing can interfere with the optical signal on the path. If obstructions can arise, for example a bird or raindrop crossing the light beam, mechanisms to ensure error-free transmission are required.

### SUMMARY OF THE INVENTION

The object of the present invention is to improve the method of the type described in the introduction with the simplest possible means, such as to ensure a reliable transmission of optical signals through free space.

In accordance with the invention, this object is achieved in an equally surprisingly simple and effective manner in that, prior to its transmission, the signal to be transmitted is split into signal packets, that each signal packet is assigned a signal sequence characteristic of the signal packet and is transmitted together with the relevant signal packet with a higher bit rate than the original signal, and that the characteristic signal sequences are used to detect, and optionally correct, errors in the transmitted signal and/or to synchronise the transmission path.

The method according to the invention offers a simple method for reliable and error-free transmission of optical signals through free space. Prior to the actual information transmission, the two stations between which the transmission via the free optical link takes place, namely the optical transmitter and the optical receiver, are synchronised. As soon as this has taken place, a synchronisation of the signal packets is achieved by means of a suitable status machine which is operated using analysis of the error-correction capabilities of the relevant signal packet. This means that in the event that the system detects errors in a number of consecutive signal packets, it is assumed that the system has become “out of step” and must be resynchronised.

A particularly preferred variant of the method according to the invention is that in which the signal packets are re-transmitted when, upon the detection of an error, the error cannot be corrected.

In another, particularly advantageous variant of the method according to the invention it is provided that, for the transmission of the signal packets, a

bit rate (X+N)·(1+p) bit/s

is selected where

X=bit rate of the signal to be transmitted,

N=bit rate of the characteristic signal sequence,

p=probability that a signal packet must be re-transmitted due to a transmission error.

Another particularly preferred variant of the method according to the invention provides that the signal packets to be transmitted are intermediately stored at the source end, and the transmitted signal packets at the receiver end, in a respective buffer memory. In this way delays in the path of the various optical signals can be compensated in problem-free manner by suitable timing of the signal transmission on the free optical link.

With this type of signal transmission, the timing is crucial in order to avoid an unnecessary administration overhead. To render this mechanism technically implementable, the signals must be buffered at the transmitter end and receiver end. The constant signal flow is ensured by means of a suitable buffer management.

In another advantageous method variant, a CRC (=cyclic redundancy check) sum, known per se, is used as characteristic signal sequence.

Signals for information transfer are normally transmitted in a frame structure. Typical frame structures in this context are STM-N (=synchronous transport module) frames in SDH (=synchronous digital hierarchy) technology.

Alternatively however, the signals to be transmitted can also be structured for example in an OTM (=optical transport module) frame. In such a case use is made of the relatively new OTH (=optical transport hierarchy) for optical channels.

Other signal transmission mechanisms are for example SONET- or ATM- technology.

A particularly preferred variant of the method according to the invention is characterised in that the signal to be transmitted is multiplied or split into two or more identical signals, that each of these mutually identical signals is transmitted from an optical transmitter to an optical receiver, in each case as an optical signal, via its own optical path comprising at least one free optical link, and that the received signals are combined via a signal combiner and fed as one single signal to the signal sink.

In this way, in a manner which is entirely independent of the signal packeting according to the invention and the assignment of characteristic signal sequences, it can again be ensured that transmission errors, such as can occur for example in the case of an interruption in the free optical link when an obstruction such as a bird, dust particle, raindrop or snowflake enter the line of sight, are absolutely reliably avoided.

The scope of the present invention also includes a signal transmission device for supporting this method variant according to the invention with a signal source for generating a signal to be transmitted, a signal splitter for multiplying or splitting this signal into two or more identical signals, a quantity of optical paths, corresponding to the number of these mutually identical signals, each of which optical paths comprises at least one free optical link, one or more optical receivers for receiving the transmitted optical signals, and a signal combiner in which the transmitted signals can be combined and fed as one single signal to a signal sink.

The scope of the present invention also includes a server unit, a processor module and a gate-array module for supporting the above described method according to the invention, and a computer program for the execution of the method. The method can be implemented both as a hardware circuit and also in the form of a computer program. Currently preference is given to software programming for high-power DSPs, as new developments and additional functions can be more easily implemented by changing the software on an existing hardware basis. However the method can also be implemented as hardware modules in devices for signal transmission, for example in an IP (=internet protocol) network or a telecommunications system.

Further advantages of the invention will become apparent from the description and the drawing. Also, in accordance with the invention, the features referred to in the foregoing and those to be referred to in the following can in each case be used individually or jointly in any combinations. The illustrated and described embodiments are not to be considered as definitive, but rather by way of example for the description of the invention.

### BRIEF DESCRIPTION OF THE DRAWINGS

The invention is illustrated in the drawing and will be explained in detail in the form of exemplary embodiments. In the drawing:

FIG. 1 is a fundamental diagram of the mode of operation of the signal transmission according to the invention by means of a plurality of mutually identical optical signals, each of which are transmitted via their own free optical link and

FIG. 2 is a diagram of a possible division of the signal to be transmitted into different signal packets according to the method corresponding to the invention.

### DETAILED DESCRIPTION OF THE INVENTION

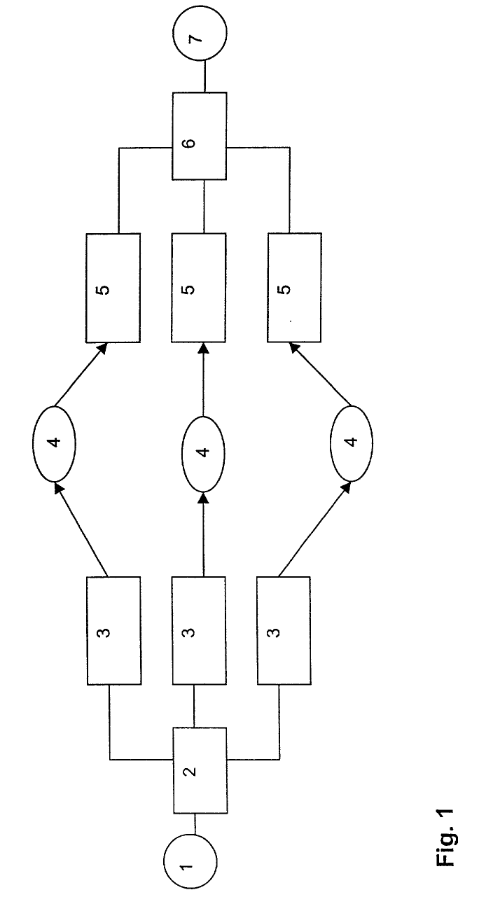

FIG. 1 illustrates a signal transmission device for supporting the above described method variant according to the invention, which provides splitting of the signal to be transmitted into a plurality of identical signals with the same information content as the original signal, and the transmission thereof via their own respective free optical link.

Here the signal to be transmitted is generated in a signal source 1. At this point for example the signal in question can still be an electrical signal, but also already an optical signal. In a downstream signal splitter 2, the signal to be transmitted is now multiplied into a plurality of identical signals, in the present case three signals, each of which are fed to an optical transmitter 3, in particular a laser. From here the optical signals are each transmitted on their own respective free optical link, on which optical relays 4 such as amplifiers or deflectors can also be arranged, to a respective, associated optical receiver 5. The received signals of the various optical receivers 5 are fed to a signal combiner 6 where they are combined to form one single signal and transmitted to a signal sink 7 which represents the destination of the overall signal transmission.

The method according to the invention can also be implemented however in a considerably simpler signal transmission device with only one single free optical link.

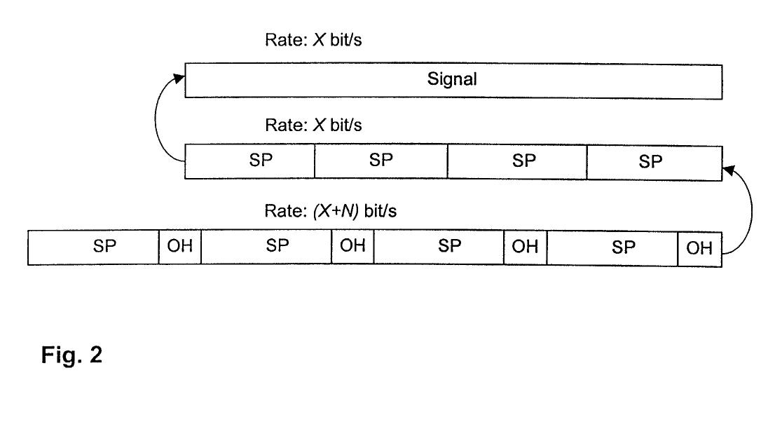

A crucial feature of the method according to the invention is the splitting of the signal to be transmitted, prior to its transmission, into different signal packets SP as schematically illustrated in the central part of FIG. 2. Then each signal packet SP is assigned a signal sequence OH characteristic of the relevant signal packet SP and transmitted together with the relevant signal packet SP with a higher bit rate than the original signal, as indicated in the lower part of FIG. 2. If the bit rate for the original signal amounted to X bit/s, the split signal is transmitted together with the characteristic signal sequences OH with a rate of (X+N) bit/s.

The characteristic signal sequences OH are then used to detect, and optionally correct, errors in the transmitted signal and/or to synchronise the transmission link.

What is claimed is:

1. A method for transmitting a signal for the transfer of information from a signal source to a signal sink spatially remote from each other, wherein, at least over a part of the path between the signal source and the signal sink, the signal is transmitted as an optical signal across at least one free optical link between an optical transmitter and an optical receiver, the method comprising the steps of
prior to its transmission, splitting the signal to be transmitted into signal packets,
assigning to each signal packet a signal sequence characteristic of the signal packet, and
transmitting the signal sequence together with the corresponding signal packet at a higher bit rate than the original signal,
wherein the characteristic signal sequences are used to detect, and optionally correct, errors in the transmitted signal and/or to synchronise the transmission path.

2. A method according to claim 1, wherein the signal packets are re-transmitted when, upon the detection of an error, this cannot be corrected.

3. A method according to claim 2, wherein for the transmission of the signal packets a
bit rate (X+N)·(1+p) bit/s
is selected where
X=bit rate of the signal to be transmitted,
N=bit rate of the characteristic signal sequence,
p=probability that a signal packet must be re-transmitted due to a transmission error.

4. A method according to claim 1, wherein the signal packets to be transmitted are intermediately stored at the source end, and the transmitted signal packets at the receiver end, in a respective buffer memory.

5. A method according to claim 1, wherein a CRC (=cyclic redundancy check) sum is selected as characteristic signal sequence.

6. A method according to claim 1, wherein the signals to be transmitted are structured in a STM-N (=synchronous transport module) frame.

7. A method according to claim 1, wherein the signals to be transmitted are structured in an OTM (=optical transport module) frame.

8. A method according to claim 1, wherein the signal to be transmitted is multiplied or split into two or more identical signals, wherein each of these mutually identical signals is transmitted from an optical transmitter to an optical receiver as an optical signal via its own optical path comprising at least one free optical link, and wherein the received signals are combined via a signal combiner and fed as one single signal to the signal sink.

9. A signal transmission device for transmitting a signal for the transfer of information from a signal source to a signal sink spatially remote from each other, wherein, at least over a part of the path between the signal source and the signal sink, the signal is transmitted as an optical signal across at least one free optical link between an optical transmitter and an optical receiver, said transmission device comprising:
a signal source for generating a signal to be transmitted,
a signal splitter for multiplying or splitting this signal into two or more identical signals,
a quantity of optical paths, corresponding to the number of these mutually identical signals, each of which optical paths comprises at least one free optical link,
one or more optical receivers for receiving the transmitted optical signals, and
a signal combiner for combining the transmitted signals and for feeding the transmitted signals as one combined signal to a signal sink.
